(19) United States
(12) Patent Application Publication
(10) Pub. No.: US 2009/0190352 A1
(43) Pub. Date: Jul. 30, 2009

(54) LIGHT-GENERATING DEVICE

(75) Inventors: Onno Van Tertholen, Eindhoven (NL); Theodoor Hubert Stommen, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/303,374

(22) PCT Filed: Jun. 19, 2007
(86) PCT No.: PCT/IB07/52339

§ 371 Date: Dec. 4, 2008

(30) Foreign Application Priority Data
Jun. 22, 2006 (EP) 06115880.4

(51) Int. Cl. F21V 21/00

(52) U.S. Cl. 362/249.02

(57) ABSTRACT

A light-generating device (1; 11) comprises at least one LED light source device (4) mounted on a front surface (7) of an MCPCB (2). The light-generating device (1; 11) further comprising a body (5) of open-cell metal foam, having a back surface (8) and a chamber (6) recessed in its back surface (8), the back surface (8) of the body (5) of open-cell metal foam being attached to the front surface (7) of the MCPCB (2) with the LED light source device (4) being arranged in the said chamber (6). The metal foam (5) preferably is aluminium, like the MCPCB (2). The metal foam (5) contributes substantially to the heat sinking and cooling of the device, effectively causes the output light to be diffused and become more homogenous, and provides a mechanical protection for the front side of the LED.

### FIELD OF THE INVENTION

The present invention relates in general to a light-generating device comprising at least one high-power LED light source.

### BACKGROUND OF THE INVENTION

The use of high-power light-emitting diodes (LEDs), especially but not exclusively white light LEDs, for illumination purposes is well known. It is also well known that heat sinking is an important issue in such devices. To this end, it is already known to mount a LED structure on a metal core printed circuit board (MCPCB), which has an aluminium core electrically insulated from the printed circuit of the board. The LED structure is mounted in a heat-transferring relationship with the aluminium core, so that this core can act as heat sink.

An object of the present invention is to improve this design in order to enhance the heat sinking properties.

In general, LEDs are bright, high-intensity, point-like light sources, which is not always desirable in illumination situations where a more diffuse light output would be more desirable. A further object of the present invention is therefore to improve the design of light-generating devices of the above type such as to provide a more diffuse and homogenous light output.

Further, LEDs are relatively vulnerable. The MCPCB on which a LED is mounted provides mechanical protection at the back of the LED, but the front side, where the light emanates, is not so protected. A further object of the present invention is therefore to improve the design of light-generating devices of the above type such as to provide a better mechanical protection of the LED.

Specifically, the present invention aims to attain the above objectives in one and the same device.

### SUMMARY OF THE INVENTION

According to the present invention, a body of open-cell foam aluminium is arranged in front of the LED and attached to the MCPCB.

A first important effect is that the MCPCB will transfer heat to the foam aluminium. Air flowing in the foam will have a cooling effect. In view of the open cell structure, air can freely flow through the foam, and in view of the large surface area of the cells the transfer of heat from the foam to the air is very good. Thus, the foam aluminium contributes substantially to the heat sinking and cooling of the device.

A second important effect is that the foam aluminium will effectively cause the output light to be diffused and become more homogenous.

A third important effect is that the foam aluminium is rigid and provides a mechanical protection for the front side of the LED.

It is noted that British patent GB-1.311.409 discloses the use of a light-transmissive plastic foam to alter the appearance of a light source. A TL tube is placed in a mould, and plastic material is poured into the mould to become a foam. The foam makes the light from the lamp diffuse and homogenous. However, this foam also operates as a thermal insulator increasing the temperature of the lamp, so that the publication even suggests to add cooling means. The publication also mentions foam aluminium, but only as an optically dense material for blocking light transmission.

It is further noted that international patent publication WO 2005/106926 discloses a light-generating device comprising at least one light-emitting die on a MCPCB, which acts as a heat sink. Opposite the MCPCB, a light-transmissive glass dome extends over the dice, the dome being provided with a phosphor material on its inner surface. For the observer outside the dome, it appears that the dome is a source of diffuse light. However, the dome does not contribute to heat sinking.

It is further noted that international patent publication WO 2005/011350 discloses the use of a body of metal foam as a heat sink in a light-generating device comprising a light-emitting die mounted on a heat spreader. However, the body of metal foam is attached to the backside of the heat spreader, i.e. opposite the die, so it does not profit from the air freely flowing in front of the LED.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 schematically illustrates the design of a light-generating device;

FIG. 2 is a schematic cross-section of a light-generating device with a plurality of light sources.

### DETAILED DESCRIPTION OF THE INVENTION

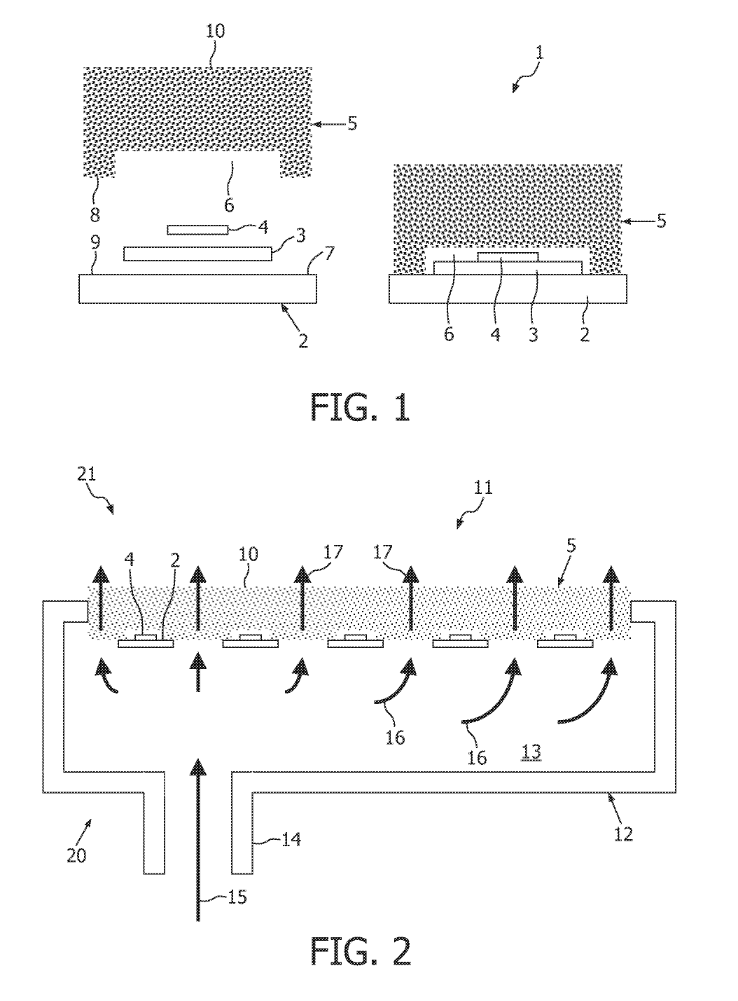

FIG. 1 schematically illustrates the design of a light-generating device 1 according to the present invention, as well as a manufacturing process for manufacturing the device.

A screen-printed prepreg 3 is mounted onto a front surface 7 of an MCPCB 2. Since screen-printed prepregs and MCPCBs are known per se, while also methods for mounting a prepreg onto an MCPCB are known per se, while further the prior art methods for manufacturing prepregs and MCPCBs can be used in implementing the present invention, this will not be explained in more detail here. It suffices to say that the size of the prepreg 3 is smaller than the size of the MCPCB 2, and that the prepreg 3 is mounted on a central portion of the MCPCB 2, so that around the prepreg 3 an annular portion 9 of the front surface 7 of the MCPCB 2 remains free.

A high-power LED light source device 4 is mounted onto the prepreg 3. Since such LED devices are known per se, while also methods for mounting a LED onto a prepreg are known per se, while further the prior art LEDs and the prior art methods for mounting a LED onto a prepreg can be used in implementing the present invention, this will not be explained in more detail here.

A body 5 of open-cell metal foam has a chamber 6 recessed in its back surface 8. Since open-cell metal foam is known per se, while prior art metal foam can be used in implementing the present invention, it is not necessary here to explain metal foam in more detail. It is further noted that methods for machining metal foam such as to make a recessed chamber are also known per se, so this also does not need to be explained in more detail here.

The metal foam body 5 is placed on the MCPCB 2, so that its back surface 8 contacts the free annular portion 9 of the front surface 7 of the MCPCB 2, while the LED 4 is located in the chamber 6 of the foam body 5. The size of the chamber 6 is preferably chosen such that the LED does not contact the body 5.

Then, the metal foam body 5 is attached to the MCPCB 2, in such a way that a good thermal contact as well as a robust mechanical contact is achieved. Although attachment by gluing is not to be excluded, preferred processes are soldering, brazing, or welding. In order to facilitate these processes, it is preferred that the material of the metal foam is the same as the metal of the core of the PCB, the preferred material being aluminium.

In FIG. 1, the body 5 is shown as a rectangular block shape, but this is not essential. For instance, in an alternative design the body 5 may have a convex outer surface, for instance a semi-cylindrical or even semi-spherical outer surface.

In FIG. 1, the extent of the body 5 is shown as being somewhat smaller than the extent of the MCPCB 2. However, the extent of the body 5 may also be equal to or somewhat larger than the extent of the MCPCB 2.

The light-generating device 1 of FIG. 1 comprises one LED with associated MCPCB and metal foam body. Alternatively, it is also possible that two or more LEDs are mounted on the MCPCB 2, either in the same chamber 6 or in separate chambers. FIG. 2 illustrates a particular embodiment 11, wherein the metal foam body 5 is provided with a plurality of recessed chambers 6 in its back surface 8, and wherein a plurality of MCPCBs 2 each with one or more LEDs 4 is attached to the back surface 8 of the foam body 5, always with the LED or LEDs 4 located in a corresponding chamber 6. The distance between neighboring chambers 6 may be such that, in operation, the front surface 10 of the metal foam body 5 shows individual yet diffuse light spots, or the neighboring chambers 6 may be located close to each other such that the entire front surface 10 appears to be one homogenous light-emitting surface.

As regards mounting of the device 1 or 11, it is noted that the metal foam 5 has mechanical strength so it may be used as structural element in mounting the device 1 or 11. This is also illustrated in FIG. 2, where the device 11 is mounted in a housing 12, the metal foam 5 being connected to the housing 12. Alternatively, the device 11 may be connected to the housing in a different way.

In the particular embodiment of FIG. 2, the housing 12 has a chamber 13 with an air inlet 14. The chamber 13 is entirely enclosed by the housing 12, the only communication with the outside environment being through the metal foam 5. If the air inlet 14 is connected to a source of gas (e.g. air, either fresh outside air or conditioned air, e.g. heated or cooled), an airflow 15 entering the chamber 13 leaves the chamber 13 via the foam 5, as indicated by arrows 16 and 17, thus cooling the foam 5 and hence cooling the LEDs 4. Thus, the housing 12 can be suitably designed as a particularly useful outlet device 20 for an air conditioner system, providing airflow and illumination at the same time.

In all cases, according to the present invention, the metal foam 5 contributes substantially to the heat sinking and cooling of the device 1 or 11, effectively causes the output light to be diffused and become more homogenous, and provides a mechanical protection for the front side of the LED or LEDs.

In an experimental setup, a metal foam body was used having a porosity of 40 ppi (pores per inch) and a density of about 7%. A satisfying result was obtained when the foam body had a thickness of 5 mm. It is noted that the qualification “satisfying” depends partly on the taste of the experimentator, and on the expected properties. If the foam body has larger pores or more pores per unit volume, the thickness should be increased to maintain the same result. Further, it should be clear that if the foam is very dense or very thick, the light output may be inadequate.

It should be clear to a person skilled in the art that the present invention is not limited to the exemplary embodiments discussed above, but that several variations and modifications are possible within the protective scope of the invention as defined in the appending claims.

1. A light-generating device comprising: at least one LED light source device mounted on a front surface of an MCPCB; and a body of open-cell metal foam, having a back surface and defining a chamber recessed in the back surface, the back surface of the body of open-cell metal foam being attached to the front surface of the MCPCB with the LED light source device being arranged in the chamber.

2. The light-generating device according to claim 1, wherein the body of open-cell metal foam and the MCPCB are attached to each other by soldering, brazing, or welding.

3. The light-generating device according to claim 1, wherein the body of open-cell metal foam is made from a metal equal to the metal of the core of the MCPCB, this metal preferably being aluminium.

4. The light-generating device according to claim 1, wherein two or more LED light source devices are arranged in the one chamber.

5. (canceled)

6. The light-generating device according to claim 1, wherein the metal foam body is mounted in a housing, the metal foam being connected to the housing.

7. The light-generating device according to claim 6, wherein the metal foam body is mounted in an outlet opening of a chamber in a housing, the housing having an gas inlet (14), such that a gas flow entering the chamber can leave the chamber via the foam body.

8. Outlet device (20) for an air conditioner system (21), comprising at least one light-generating device according to claim 7.

9. (canceled)
